(19) United States
(12) Patent Application Publication
(10) Pub. No.: US 2026/0182554 A1
(43) Pub. Date: Jul. 2, 2026

(54) Bionic Fishing Lure

(71) Applicant: SHUAN YEW ENTERPRISE CO., LTD., CHANGHUA COUNTY (TW)

(72) Inventor: Yuan-Chieh Su, CHANGHUA COUNTY (TW)

(21) Appl. No.: 19/390,864

(22) Filed: Nov. 17, 2025

Related U.S. Application Data
(63) Continuation of application No. 19/001,861, filed on Dec. 26, 2024.

(51) Int. Cl. A01K 85/00

(52) U.S. Cl. CPC A01K 85/1881

(57) ABSTRACT

Provided is a bionic fishing lure including a body and a plurality of rib elements. The rib elements are disposed on two opposing lateral spinal surfaces of a spine portion of the body. The two opposing lateral surfaces of the rib elements each have a plurality of corrugated structures corresponding in position to each other, allowing every two adjacent ones of the corrugated structures on the same lateral surface to enter and abut against each other. Therefore, the bionic fishing lure in zigzag motion in water looks real.

This is a continuation application of and claims priority to the U.S. application Ser. No 19/001,861 filed on Dec. 26, 2024, the disclosure of which is incorporated by reference herein.

### BACKGROUND

### Field of Invention

The present disclosure relates to fishing lures, and more particularly to a bionic fishing lure.

### Description of Related Art

As shown in FIG. 1A through FIG. 1C, an existing conventional bionic fishing lure is characterized in that a plurality of ribs C are protrudingly disposed on each of two opposing lateral surfaces B of spine A. However, the distance between every two adjacent ones of the ribs C on the same side in the horizontal direction is too long, and in consequence the adjacent ribs C are unable to support and restrain each other. As a result, not only is the rear half of the bionic fishing lure likely to sink in the vertical direction, but the zigzag motion of the bionic fishing lure in the horizontal direction is also unnatural.

As shown in FIG. 2A through FIG. 2C, another existing conventional bionic fishing lure is characterized in that a plurality of bionic scale elements D are protrudingly disposed on each of two opposing lateral surfaces B of spine A. However, every two adjacent ones of the bionic scale elements D on the same side are staggered, and in consequence the force exerted by the adjacent bionic scale elements D to support and restrain each other in the vertical direction and the horizontal direction is insufficient. As a result, the longer the bionic fishing lure is, the more likely its rear half sinks excessively in the vertical direction, not to mention that the zigzag motion of the bionic fishing lure in the horizontal direction is unnatural.

### SUMMARY

It is an objective of the disclosure to provide a bionic fishing lure whose protrusions exert a sufficient force to support and restrain each other in the vertical direction and the horizontal direction.

To achieve the above and other objectives, the disclosure is a bionic fishing lure with a lateral surface structure and protrusions, wherein the lateral surface structure enables the protrusions to exert a sufficient force to support and restrain each other in the vertical direction and the horizontal direction. Thus, even if the bionic fishing lure is of an excessive length, not only will the rear half of the bionic fishing lure refrain from sinking excessively in the vertical direction, but the zigzag motion of the bionic fishing lure in the horizontal direction will also look natural.

An embodiment of the disclosure provides a bionic fishing lure, comprising: a body comprising a head portion, a spine portion and a tail portion, with the spine portion disposed at the head portion and the tail portion and connected between the head portion and the tail portion; and a plurality of rib elements disposed on two opposing lateral spinal surfaces of the spine portion and extending in a vertical direction, wherein, in a horizontal direction, every two opposing lateral surfaces each have a corrugated structure, allowing every two adjacent ones of the rib elements to enter and abut against each other through the corrugated structures.

Optionally, the rib elements each not only extend in the vertical direction, but the opposing lateral surfaces are also defined as a first surface and a second surface in the horizontal direction respectively. A corrugated structure on the first surface has a plurality of first convex portions and a first concave portion disposed between every two adjacent ones of the first convex portions, and a corrugated structure on the second surface has a plurality of second convex portions and a second concave portion disposed between every two adjacent ones of the second convex portions. Every two adjacent ones of the rib elements are defined as a first rib element and a second rib element respectively. The first surfaces of the first rib elements face the second surfaces of the second rib elements respectively. The first convex portions of the first rib elements are adapted to enter the second concave portions of the second rib elements respectively, and the second convex portions of the second rib elements are adapted to enter the first concave portions of the first rib elements respectively.

Optionally, the first convex portions each have a first upper support surface and a first lower support surface, and an included angle between the first upper support surface and the first lower support surface is greater than 0° and less than 180°. The second convex portions each have a second upper support surface and a second lower support surface, and an included angle between the second upper support surface and the second lower support surface is greater than 0° and less than 180°. When one of the first rib elements and an adjacent one of the second rib elements abut against each other, the first upper support surface of at least one of the first convex portions of the first rib element and the second lower support surface of at least one of the second convex portions of the second rib element abut against each other, alternatively the first lower support surface of at least one of the first convex portions of the first rib element and the second upper support surface of at least one of the second convex portions of the second rib element abut against each other.

Optionally, the rib elements are made of a material different from that of the spine portion.

Optionally, the rib elements are of hardness or elasticity different from that of the spine portion.

Optionally, the rib elements each have a plurality of pores, and a diameter of the pores is less than a distance between every two adjacent ones of the rib elements.

Optionally, the rib elements each have a plurality of pores invisible to the naked eye.

Optionally, the rib elements each have at least one hole or groove.

### BRIEF DESCRIPTION OF THE DRAWINGS

Aspects and advantages of the disclosure are described below and disclosed by the accompanying drawings as follows:

FIG. 1A is a schematic view of an existing conventional bionic fishing lure.

FIG. 1B is a top view of the bionic fishing lure shown in FIG. 1A and being motionless.

FIG. 1C is a top view of the bionic fishing lure shown in FIG. 1A and being in zigzag motion.

FIG. 2A is a schematic view of another existing conventional bionic fishing lure.

FIG. 2B is a top view of the bionic fishing lure shown in FIG. 2A and being motionless.

FIG. 2C is a lateral view of the bionic fishing lure shown in FIG. 2A and being in zigzag motion.

FIG. 3 is a schematic view of a bionic fishing lure according to an embodiment of the disclosure.

FIG. 4 is a top view of the bionic fishing lure shown in FIG. 3 and being motionless.

FIG. 5 is a bottom view of the bionic fishing lure shown in FIG. 3 and being motionless.

FIG. 6 is a lateral view of the bionic fishing lure shown in FIG. 3 and being in zigzag motion.

FIG. 7 is a schematic view of the bionic fishing lure according to an embodiment of the disclosure.

FIG. 8 is a schematic view of the bionic fishing lure according to an embodiment of the disclosure.

FIG. 9 is a partial enlarged view of the bionic fishing lure shown in FIG. 8.

FIG. 10 is a top view of the bionic fishing lure shown in FIG. 8 and being motionless.

FIG. 11 is a lateral view of the bionic fishing lure shown in FIG. 8 and being in zigzag motion.

FIG. 12 is a schematic view of the bionic fishing lure according to an embodiment of the disclosure.

FIG. 13 is a schematic view of the bionic fishing lure according to an embodiment of the disclosure.

FIG. 14 is a partial enlarged view of the bionic fishing lure shown in FIG. 13.

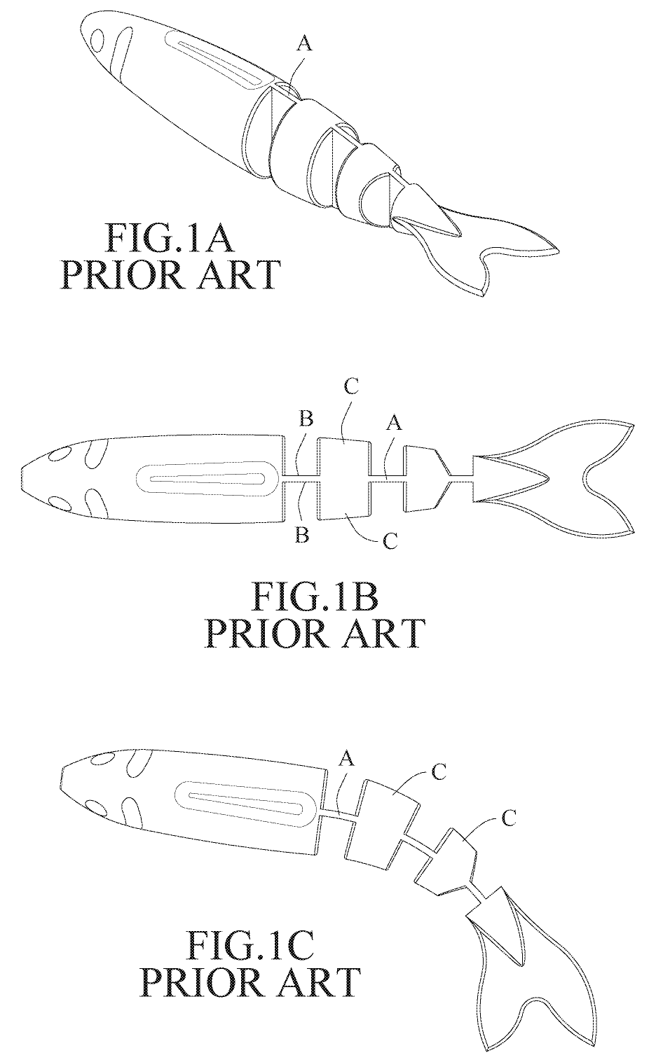

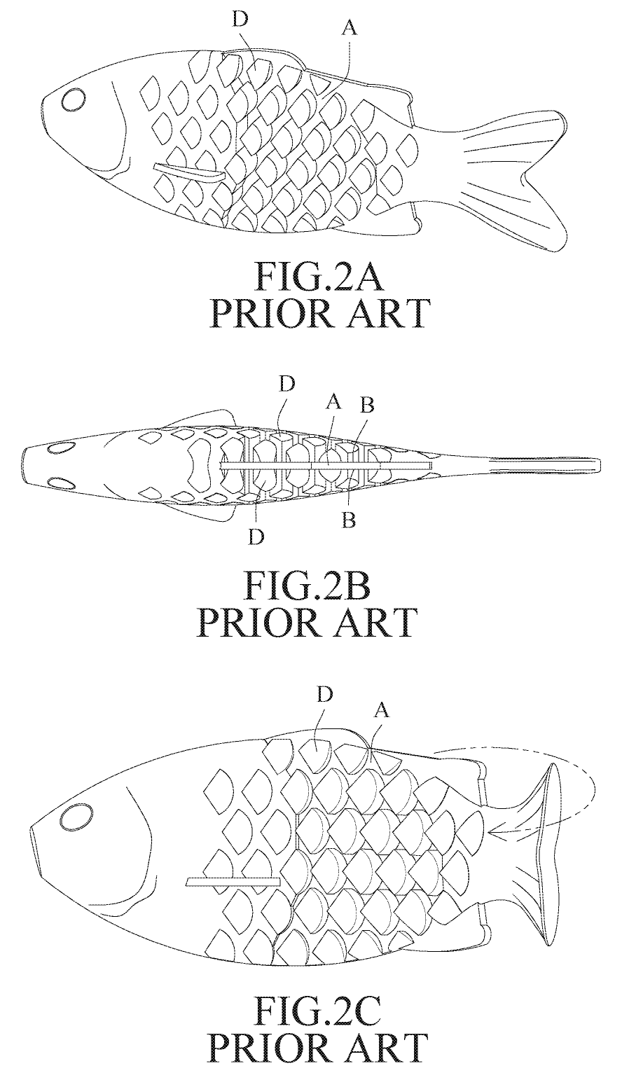

### DETAILED DESCRIPTION

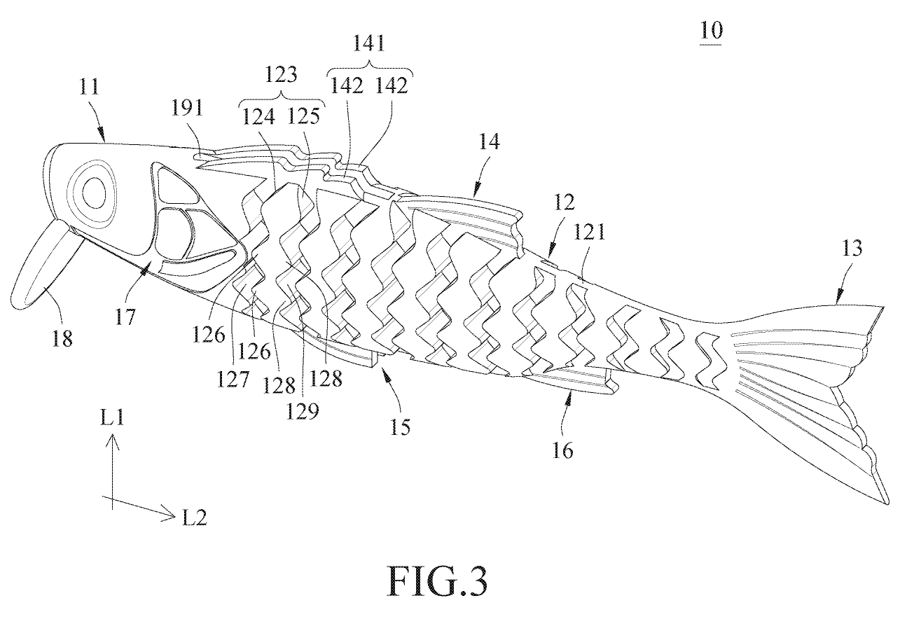

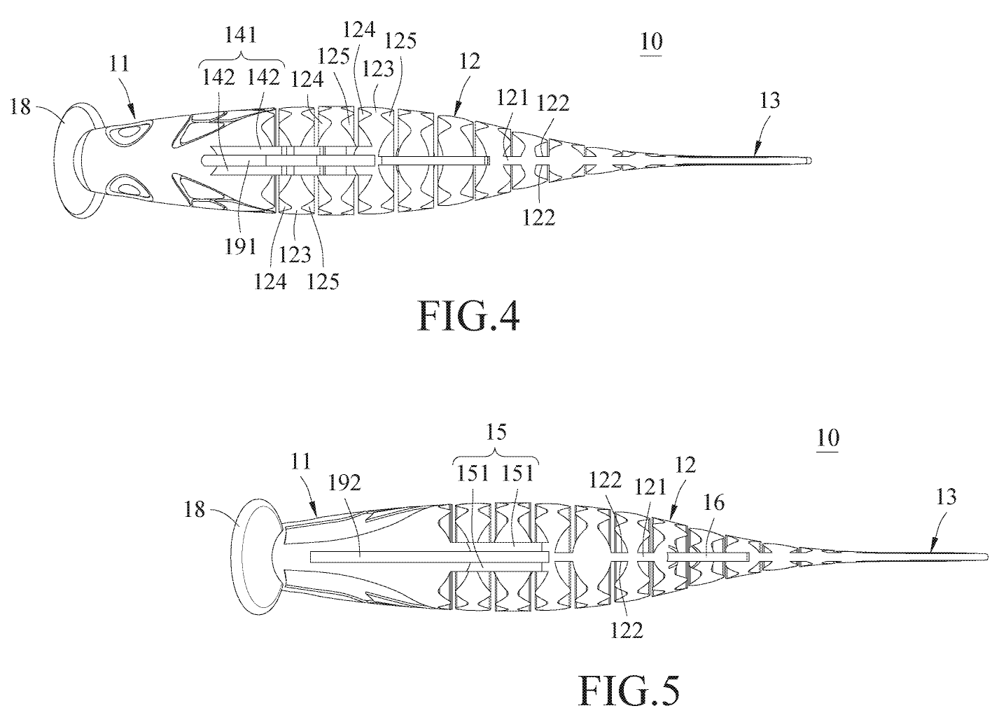

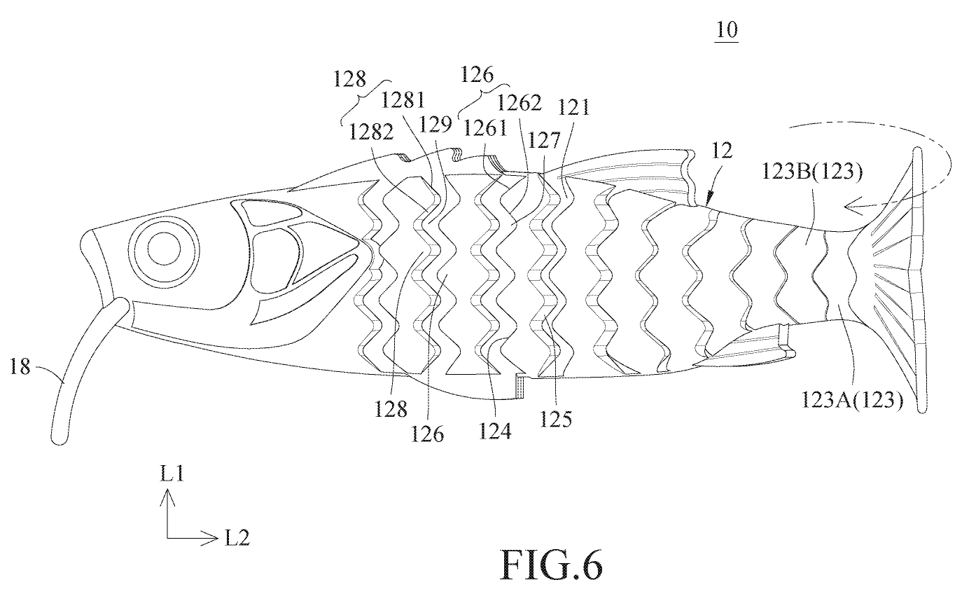

Referring to FIGS. 3 through 6, an embodiment of the disclosure provides a bionic fishing lure comprising a body 10. The body 10 comprises a bionic head 11, a bionic trunk 12, a bionic caudal fin 13, a bionic dorsal fin 14, a bionic pelvic fin 15, a bionic anal fin 16 and two bionic pectoral fins 17.

The bionic head 11 is disposed at the front end of the bionic trunk 12. The bionic caudal fin 13 is disposed at the rear end of the bionic trunk 12. The bionic dorsal fin 14 is disposed at the top of the bionic trunk 12. The bionic pelvic fin 15 and the bionic anal fin 16 are disposed at the bottom of the bionic trunk 12. The two bionic pectoral fins 17 are disposed on two opposing sides of the bionic trunk 12 respectively.

The bionic trunk 12 comprises a spine 121. Each of the two opposing lateral surfaces 122 of the spine 121 has a plurality of ribs 123. Each of the ribs 123 not only extends in a vertical direction L1 but also has a first surface 124 and a second surface 125 opposing the first surface 124 in a horizontal direction L2. The first surface 124 has a plurality of first convex portions 126 and a first concave portion 127 disposed between every two adjacent ones of the first convex portions 126. The second surface 125 has a plurality of second convex portions 128 and a second concave portion 129 disposed between every two adjacent ones of the second convex portions 128. The first convex portions 126 of each of the ribs 123 on each of the lateral surfaces 122 correspond in position to the second concave portions 129 of the adjacent ones of the ribs 123 respectively. Each of the first convex portions 126 of each of the ribs 123 is adapted to enter a corresponding one of the second concave portions 129 of an adjacent one of the ribs 123. Each of the second convex portions 128 of each of the ribs 123 is adapted to enter a corresponding one of the first concave portions 127 of an adjacent one of the ribs 123.

Each of the first convex portions 126 has a first upper support surface 1261 and a first lower support surface 1262, and the included angle between the first upper support surface 1261 and the first lower support surface 1262 is greater than 0° and less than 180°. Each of the second convex portions 128 has a second upper support surface 1281 and a second lower support surface 1282, and the included angle between the second upper support surface 1281 and the second lower support surface 1282 is greater than 0° and less than 180°. Each of the ribs 123 has at least one first convex portion 126 that jointly forms a rhombic or cuboid protrusion together with an adjacent one of the second convex portions 128 in the horizontal direction L2; however, this embodiment is not limited thereto.

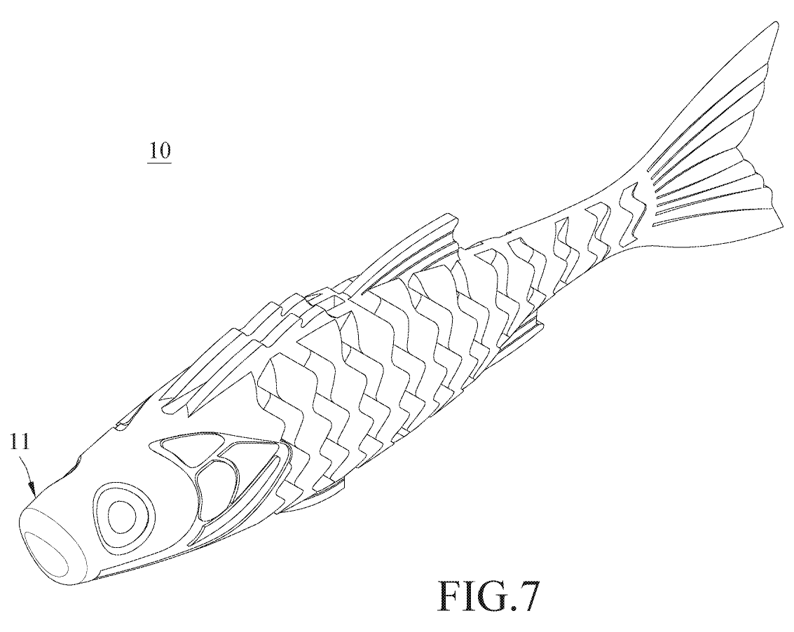

In the embodiment, the body 10 further comprises a resistance element 18. The resistance element 18 is disposed at the front end of the bionic head 11 to increase the resistance of the front end of the body 10 and thereby increase the magnitude of the zigzag motion of the bionic fishing lure. Furthermore, the resistance element 18 is sheet-shaped; however, this embodiment is not limited thereto. In a variant embodiment, the resistance element 18 otherwise shown in FIG. 3 is dispensed with (see the bionic head 11 of the body 10 shown in FIG. 7).

The body 10 further comprises at least one holding groove which a bait can be placed in. In the embodiment, holding grooves 191 and 192 are disposed at the top and the bottom of the bionic trunk 12 respectively. The holding groove 191 is disposed between two separate dorsal fins 142 of the bionic dorsal fin 14. The two dorsal fins 142 are disposed at a front dorsal fin zone 141 of the bionic dorsal fin 14. The holding groove 192 is partially disposed between two separate two pelvic fins 151 of the bionic pelvic fin 15. However, this embodiment is not limited thereto.

In the embodiment, the body 10 is made of an elastic material; however, this embodiment is not limited thereto.

According to the disclosure, at least one of the bionic head 11, bionic caudal fin 13, bionic dorsal fin 14, bionic pelvic fin 15, bionic anal fin 16 and bionic pectoral fins 17 may be selectively dispensed with as needed.

The state of the bionic fishing lure in use according to the disclosure is exemplarily described below.

When the bionic fishing lure in water is in zigzag motion and thus bends, in the horizontal direction L2, adjacent ones of the ribs 123 abut against each other at every bend. Specifically speaking, when one of the first ribs 123A and an adjacent one of the second ribs 123B at the bend abut against each other, it is feasible for the first upper support surface 1261 of at least one of the first convex portions 126 of the first rib 123A and the second lower support surface 1282 of at least one of the second convex portions 128 of the second rib 123B to abut against each other, and/or for the first lower support surface 1262 of at least one of the first convex portions 126 of the first rib 123A and the second upper support surface 1281 of at least one of the second convex portions 128 of the second rib 123B to abut against each other.

Since each of the ribs 123 extends from the top of the bionic fishing lure to the bottom of the bionic fishing lure, the ribs 123 exert a supporting force in the vertical direction L1 to prevent the spine 121 from bending excessively in the vertical direction L1 and thus prevent the bionic trunk 12 from sinking excessively.

At every bend and on the same side, all the first convex portions 126 of first ribs 123A enter all the second concave portions 129 of second ribs 123B respectively, and all the second convex portions 128 of the second ribs 123B enter all the first concave portions 127 of the first ribs 123A respectively; thus, at least a portion of the first surface 124 of each of the first ribs 123A abuts against the second surface 125 of a corresponding one of the second ribs 123B to achieve position limitation in the horizontal direction L2 and restrain the amplitude of the zigzag motion of the bionic fishing lure.

The amplitude of the zigzag motion of the bionic fishing lure can be adjusted through designing the distance between each of the first ribs 123A and a corresponding one of the second ribs 123B. Preferably, at each of the bends, the first upper support surface 1261 of at least one of a plurality of first convex portions 126 of the first ribs 123A and the second lower support surface 1282 of at least one of a plurality of second convex portions 128 of the second ribs 123B abut against each other, and/or the first lower support surface 1262 of at least one of a plurality of first convex portions 126 of the first ribs 123A and the second upper support surface 1281 of at least one of a plurality of second convex portions 128 of the second ribs 123B abut against each other, not only exerting a plurality of supporting forces in the vertical direction L1, but also achieving position limitation in the vertical direction L1.

Therefore, the embodiment is effective in not only preventing the rear half of the bionic fishing lure from sinking excessively in the vertical direction L1 but also allowing the zigzag motion of the bionic fishing lure in the horizontal direction L2 to look natural and real. The embodiment will still be effective even if the bionic fishing lure is of an excessive length in the horizontal direction L2. Furthermore, the ribs 123 exhibit enormous resistance to the water that flows across the first surfaces 124 of the ribs 123 to not only be conducive to an increase in the frequency of the zigzag motion of the bionic fishing lure in the horizontal direction L2 but also render the zigzag motion natural and real.

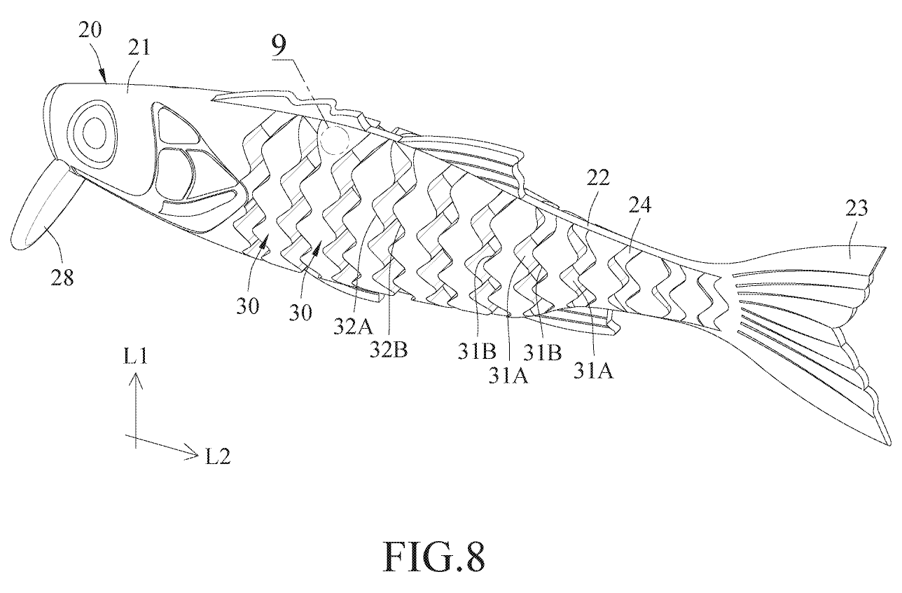

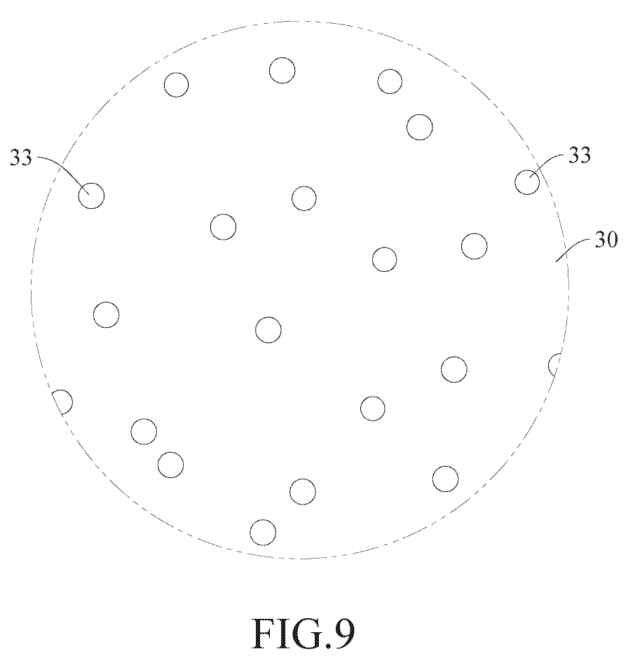

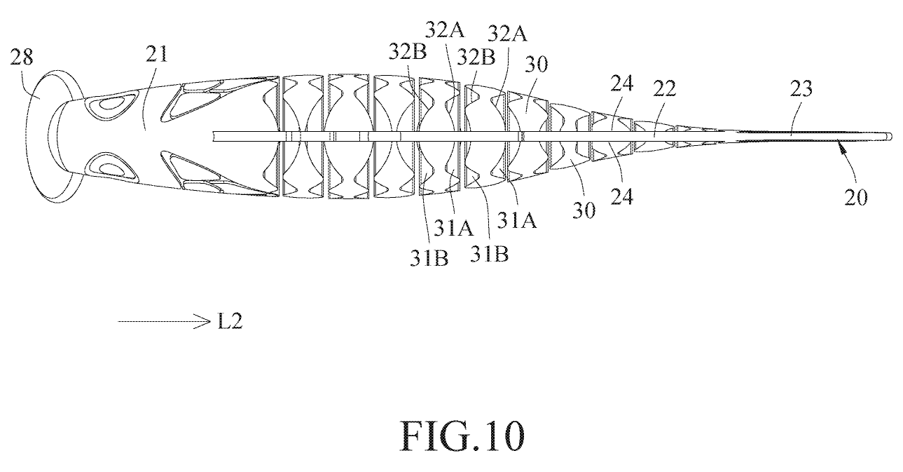

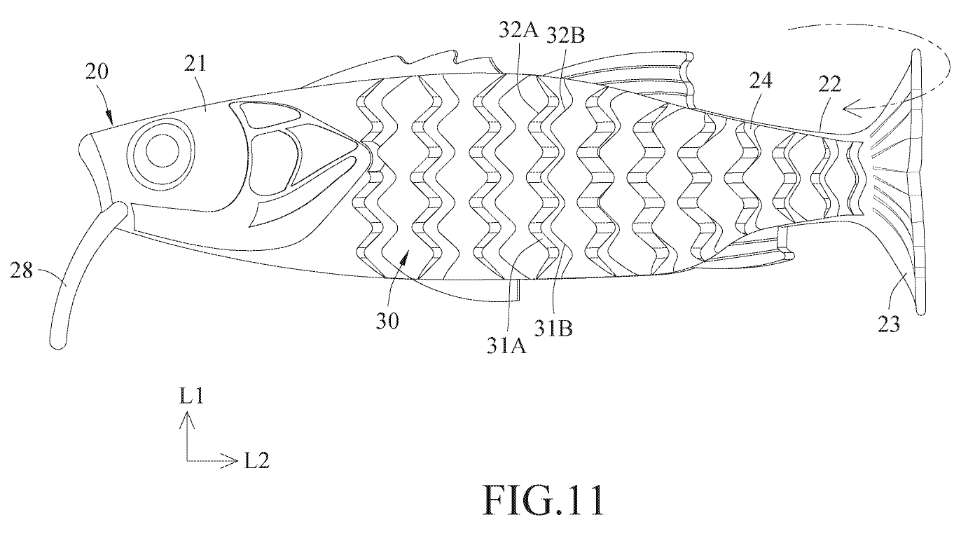

Referring to FIGS. 8 through 12, an embodiment of the disclosure provides a bionic fishing lure comprising a body 20 and a plurality of rib elements 30.

The body 20 comprises a head portion 21, a spine portion 22 and a tail portion 23. The spine portion 22 is connected to and located between the head portion 21 and the tail portion 23.

The rib elements 30 are disposed on each of two opposing lateral spinal surfaces 24 of the spine portion 22. The rib elements 30 extend in the vertical direction L1. In the horizontal direction L2, the rib elements 30 each have an opposing lateral surface 31A (i.e., a first surface) and lateral surface 31B (i.e., a second surface) which have a corrugated structure 32A and a corrugated structure 32B respectively. For every two adjacent ones of the rib elements 30 (i.e. first rib element and second rib element) on the same lateral spinal surface, the corrugated structure 32A (i.e., corrugated structure disposed on the first surface of the first rib element) and the corrugated structure 32B (i.e., corrugated structure disposed on the second surface of the second rib element and facing the first surface of the first rib element) facing each other are allowed to enter and abut against each other.

The design of the corrugated structures 32A and corrugated structures 32B of the rib elements 30 on the same lateral spinal surface 24 is the same as the design of the first convex portions 126 and the first concave portions 127 on the first surfaces 124 and the second convex portions 128 and the second concave portions 129 on the second surfaces 125 of the ribs 123, as shown in FIG. 3 through FIG. 7, and thus is, for the sake of brevity, not reiterated.

Optionally, the rib elements 30 are made of a material different from that of spine portion 22.

Optionally, the rib elements 30 are of hardness or elasticity different from that of spine portion 22.

Optionally, the rib elements 30 each have a plurality of pores 33, and the diameter of the pores 33 is less than the distance between every two adjacent ones of the rib elements 30. Preferably, the pores 33 are invisible to the naked eye. Therefore, bait can adsorb on the pores 33.

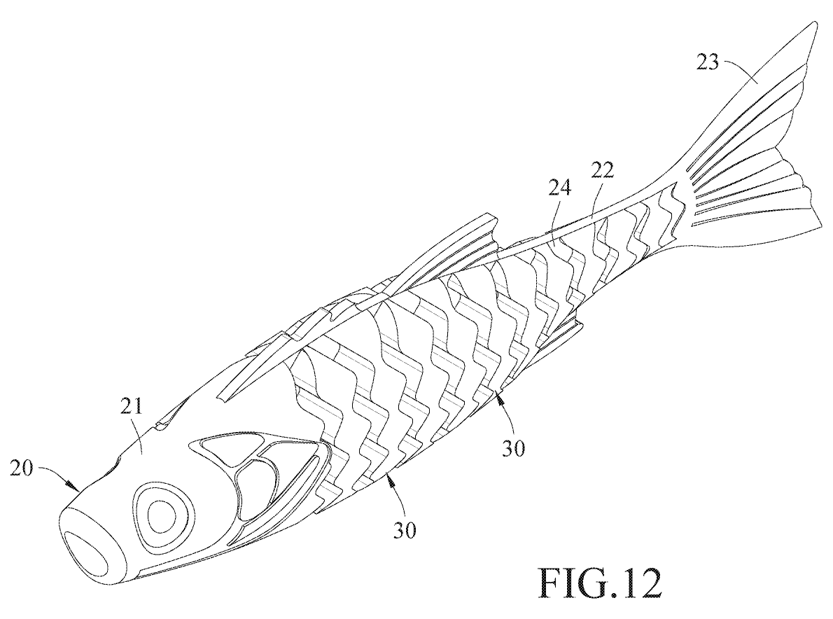

Optionally, a resistance element 28 identical or similar to the resistance element 18 shown in FIG. 3 through FIG. 6 is disposed at the head portion 21. However, the head portion 21 may dispense with a resistance element, as shown in FIG. 12.

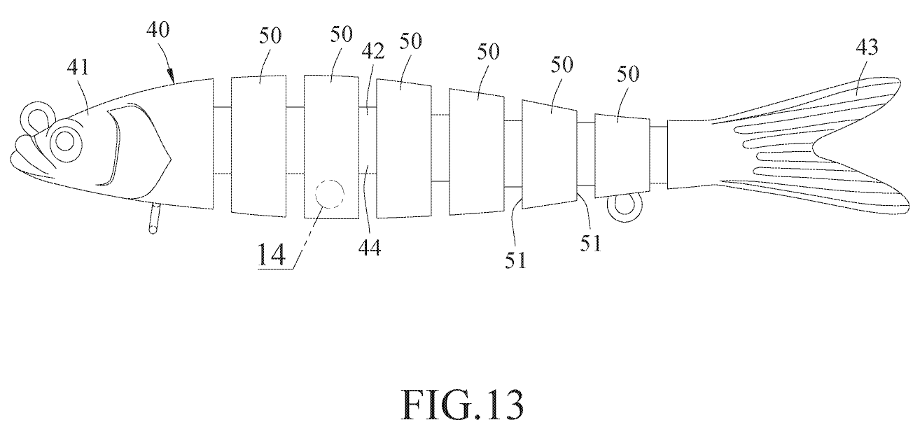

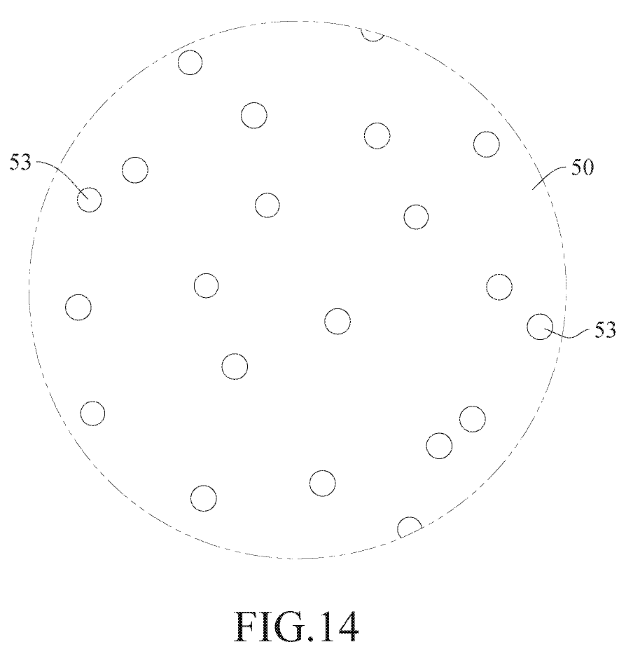

Referring to FIGS. 13 and 14, an embodiment of the disclosure provides a bionic fishing lure comprising a body 40 and a plurality of rib elements 50.

The body 40 comprises a head portion 41, a spine portion 42 and a tail portion 43. The spine portion 42 is connected to and located between the head portion 41 and the tail portion 43.

The rib elements 50 are disposed on each of two opposing lateral spinal surfaces 44 of the spine portion 42. Two opposing lateral surfaces 51 of each of the rib elements 50 are flat surfaces. Every two adjacent ones of the rib elements 50 on the same lateral spinal surface are allowed to abut against each other.

Optionally, the rib elements 50 are made of a material different from that of the spine portion 42. Optionally, the rib elements 50 are made of the same material as the spine portion 42.

Optionally, the rib elements 50 are of hardness or elasticity different from that of spine portion 42.

Optionally, the rib elements 50 each have a plurality of pores 53, and the diameter of the pores 53 is less than the distance between every two adjacent ones of the rib elements 50. Preferably, the pores 53 are invisible to the naked eye. Therefore, bait can adsorb on the pores 53.

Optionally, the rib elements 50 each have at least one hole or groove (not shown) to therefore minimize the weight of the rib elements 50. Preferably, the hole or groove stores bait or allows bait to adsorb on.

Optionally, the rib elements 50 are inseparably and integrally formed on the spine portion 22.

Optionally, the spine portion 22 is a fiber layer or net. Therefore, when a big, real fish bites the bionic fishing lure, the spine portion 22 is unlikely to be severed or fractured, maximizing the service life of the bionic fishing lure.

Optionally, the rib elements 50 are made of acrylonitrile butadiene styrene (ABS) resin, high-density foam, plastic, light aluminum alloy, ceramic or metal.

The disclosure is disclosed above by preferred embodiments. However, the embodiments are illustrative of the disclosure only, but shall not be interpreted as restrictive of the scope of the disclosure. Persons skilled in the art can make various changes and variations to the disclosure. All amendments, equivalent replacements, and improvements made to the embodiments according to the spirit and principles of the disclosure shall fall within the scope of the claims of the disclosure.

What is claimed is:

1. A bionic fishing lure, comprising:
a body comprising a head portion, a spine portion and a tail portion, with the spine portion connected to and located between the head portion and the tail portion; and
rib elements disposed on each of two opposing lateral spinal surfaces of the spine portion and extending in a vertical direction, wherein, in a horizontal direction, every two adjacent ones of the rib elements on the lateral spinal surface are allowed to abut against each other, and the rib elements each have pores for adsorbing bait.

2. The bionic fishing lure of claim 1, wherein a diameter of the pores is less than a distance between every two adjacent ones of the rib elements.

3. The bionic fishing lure of claim 1, wherein the pores are invisible to naked eye.

4. The bionic fishing lure of claim 1, wherein in the horizontal direction, the rib elements each have two opposing lateral surfaces each having a corrugated structure, and for every two adjacent ones of the rib elements on the lateral spinal surface, the corrugated structures thereon facing each other are allowed to enter and abut against each other.

5. A bionic fishing lure, comprising:
a body comprising a head portion, a spine portion and a tail portion, with the spine portion connected to and located between the head portion and the tail portion; and
rib elements disposed on each of two opposing lateral spinal surfaces of the spine portion and extending in a vertical direction, wherein in a horizontal direction, for every two adjacent ones of the rib elements on the lateral spinal surface are allowed to abut against each other, and the rib elements each have at least one hole or groove for adsorbing bait.

6. A bionic fishing lure, comprising:
a body comprising a head portion, a spine portion and a tail portion, with the spine portion connected to and located between the head portion and the tail portion; and
rib elements disposed on each of two opposing lateral spinal surfaces of the spine portion and extending in a vertical direction, wherein, in a horizontal direction, for every two adjacent ones of the rib elements on the lateral spinal surface are allowed to abut against each other, and the rib elements each have at least one hole or groove and have pores for adsorbing bait.

7. The bionic fishing lure of claim 6, wherein a diameter of the pores is less than a distance between every two adjacent ones of the rib elements.

8. The bionic fishing lure of claim 6, wherein the pores are invisible to naked eye.
